(19) United States
(12) Patent Application Publication
(10) Pub. No.: US 2009/0288628 A1
(43) Pub. Date: Nov. 26, 2009

(54) Electrically isolated rotor ground

(75) Inventors: Oran A. Watts, III, Indianapolis, IN (US); Matthew J. Starr, Indianapolis, IN (US); Robert A. Ress, JR., Carmel, IN (US)

Correspondence Address: KRIEG DEVAULT LLP, ONE INDIANA SQUARE, SUITE 2800, INDIANAPOLIS, IN, 46204-2079, US

(73) Assignee: Rolls-Royce North American Technologies, Inc., Indianapolis, IN (US)

(21) Appl. No.: 12/154,192

(22) Filed: May 21, 2008

(51) Int. Cl. F02P 7/00

(52) U.S. Cl. 123/146.5 A

(57) ABSTRACT

A thrust-producing engine includes an engine structure, a rotor that is electrically isolated from the engine structure, and an electrical conductor connected to the engine structure. The electrical conductor is in electrical contact with the engine structure and the rotor as the rotor rotates relative to the electrical conductor and the engine structure to reduce electrical arcing between the engine structure and the rotor.

The present invention was made with U.S. Government support under contract number N00014-04-D-0068 awarded by the U.S. Navy and the U.S. Navy has rights therein.

### BACKGROUND

The present invention relates generally to electrostatic charge dissipation, and more particularly, but not exclusively to electrostatic charge management for electrically isolated rotating components of engines.

Electrostatic charge build-up can result in undesirable arcing between electrically isolated components. In one example, various design considerations may subject a rotating engine component to electrical isolation that can result in an undesirable electrostatic charge accumulation. Managing electrostatic charge can be of particular concern when the engine serves as the prime mover and/or propulsion source for a vehicle. Thus, there is a need for additional contributions in this area of technology.

### SUMMARY

In one embodiment of the present application, a unique technique is provided to dissipate electrostatic charge. Other embodiments include unique apparatus, methods, devices, and systems to provide electrostatic charge management for an engine. Further embodiments, forms, features, aspects, benefits, and advantages of the present application shall become apparent from the description and figures provided herewith.

### BRIEF DESCRIPTION OF THE DRAWINGS

FIG. 1 is a schematic view of an aircraft including an engine with an electrically isolated rotor.

FIG. 2 is a partial, diagrammatic view of a portion of the engine of FIG. 1.

FIG. 3 is a schematic view of a shaft interacting with one embodiment of a non-electrically conductive brush of the present application.

FIG. 4 is a schematic view of a shaft interacting with one embodiment of a non-electrically conductive brush of the present application.

### DETAILED DESCRIPTION OF REPRESENTATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

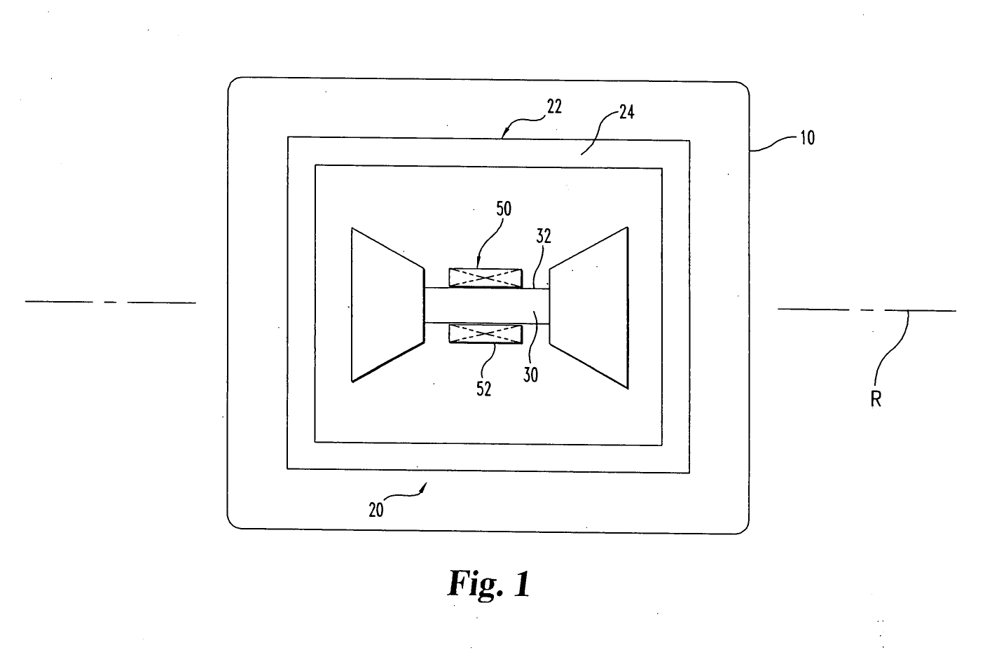

FIG. 1 diagrammatically depicts a vehicle in the form of aircraft 10 with an engine system that includes electrostatic charge management. The term aircraft is intended to be construed broadly herein and includes, but is not limited to, helicopters, airplanes, missiles and unmanned vehicles. Additionally, the present invention is also contemplated for utilization in other types of vehicles that would not generally be considered as an aircraft. In one form aircraft 10 includes a thrust-producing engine 20 that is used for propulsion. In one embodiment, the thrust-producing engine 20 is a gas turbine engine type, but other thrust-producing or non-thrust-producing engine types may be used for propulsion or nonpropulsion purposes in other embodiments. Engine 20 comprises an engine structure 22 including an engine housing 24, a rotor 30, and rotary bearing device 50. Housing 24 at least partially encloses rotor 30. In one nonlimiting implementation directed to a gas turbine engine type, rotor 30 includes at least one compressor and/or turbine and a connected shaft. The rotor 30 has rotor surface 32.

Bearing device 50 journals rotor 30 to the engine structure 22 and housing 24. Bearing device 50 includes one or more electrically insulative bearings 52 positioned between rotor 30 and engine structure 22. In one embodiment, the bearings 52 are of a magnetic type that establishes an electrically insulative air gap between structure 22 and rotor 30 to provide an “air bearing” during at least one mode of engine operation. In another embodiment, bearings 52 may be a different type, such as an electrically nonconductive ceramic rolling element bearing, an electrically nonconductive composite rolling element bearing, an electrically nonconductive foil leaf air bearing, or an electrically nonconductive fluid film bearing just to name a number of nonlimiting alternatives. In still other embodiments, a combination of different electrically insulative/nonconductive bearing types may be utilized. While such bearing types find application in various designs, the attendant nonconductive property of these bearings tends to electrically isolate the rotor, which can result in the accumulation of electrostatic charge on rotor 30 under certain conditions—especially as rotor 30 spins relative to structure 22.

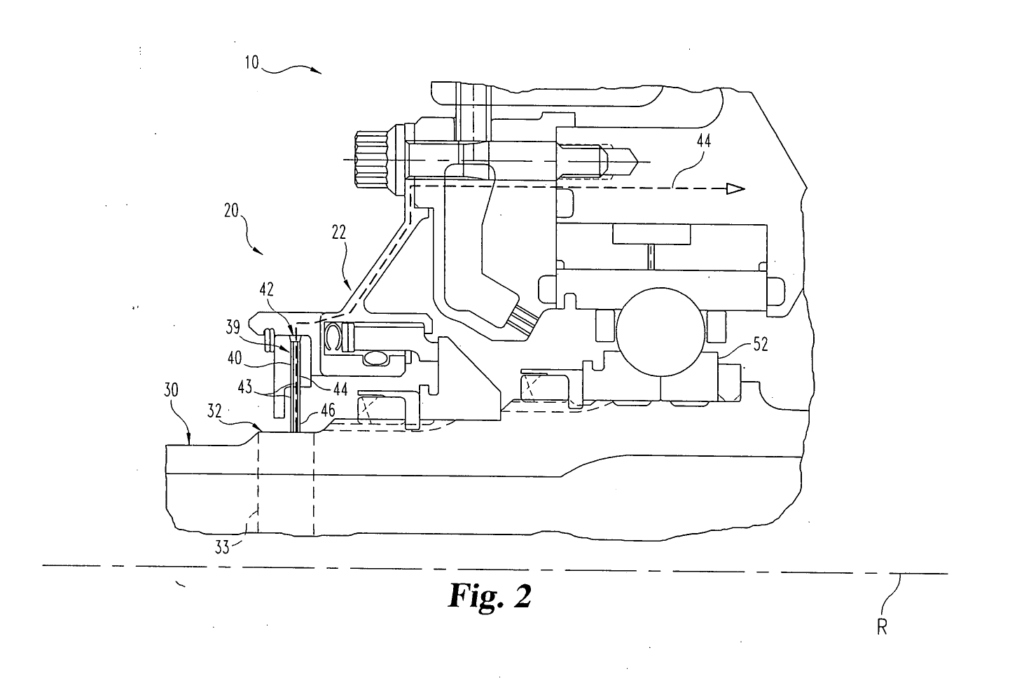

FIG. 2 illustrates a portion of engine 20 in greater detail. As depicted in FIG. 2, engine 20 includes electrostatic charge control device 39 directed to the amelioration of static charge build-up. Device 39 includes at least one electric charge conveying member in the form of electrical conductor 40 fastened to the engine structure 22. It should be appreciated that “electrical conductor” is a relative term that refers to a material and/or structure that provides a more electrically conductive path between two points than results if the electrical conductor is absent. For engine 20, conductor 40 has an electrical conductivity greater than bearings 52, and correspondingly has an electrical impedance less than bearings 52. Indeed, conductor 40 can have an electrical resistance of less than one ohm to more than several thousand ohms, depending on the specific arrangement.

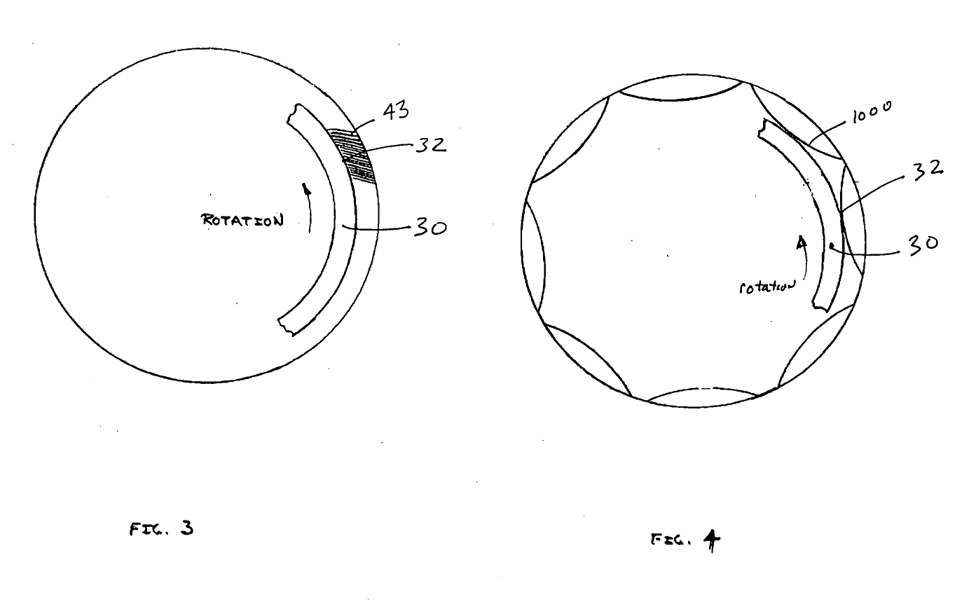

Conductor 40 is included in an electrical contact brush 42 having several electrically conductive bristles 43. Any of bristles 43 could be considered to be conductor 40. In application, a mechanical bias is applied to bristles 43 to impart an elastically deforming force thereto. One non-limiting example is set forth in FIG. 3. Bristles 43 are each made of a resilient material to press against rotor surface 32 of rotor 30 in response to this mechanical biasing—providing a form of cantilever spring. The electrically conductive bristles 43 make electrical contact with at least part of a circumferential contact surface portion 33 of the rotor surface 32. Bristles 43 slide along at least a part of surface portion 33 as rotor 30 turns. In one form surface portion 33, and perhaps some or all of the remainder of surface 32 includes an electrically conductive coating to resist wear that may otherwise result from bristle contact. In one non-limiting form of the present application the surface velocity of the rotor 30 is less than 1000 feet per second. In another non-limiting form of the present application the bristles 43 are subjected to temperatures less than 1200° F. Furthermore, in another form of the present application the brush bristles are subjected to a minimal preload against the surface.

In one embodiment, bristles 43 are composed of an electrically conductive metallic material. In other embodiments, the electrically conductive bristles 43 may be composed of one or more electrically conductive nonmetallic materials that may or may not also be combined with a metallic material. In another embodiment of device 39, an electrically conductive strip or leaf spring is bowed, and has opposing ends that are connected to structure 22. One non-limiting example of the electrically conductive strip or leaf spring 1000 is illustrated in FIG. 4. Between these ends, the bowed portion of the strip defines an arc that engages rotor 30 as it turns—providing a form of bow spring that engages rotor 30. A further embodiment of device 39 includes a rigid bar with a spring-loaded connection to engine structure 22. This connection uses a biased spring to correspondingly press the bar against rotor 30 as it turns. In still other embodiments, a different electrically conductive structure to bridge engine structure 22 and rotor 30 is utilized in addition to or as an alternative to one or more of these previously described embodiments.

During operation of engine 20, rotor 30 turns about axis R. As the rotor 30 is rotated, electrostatic charge may develop on rotor 30 in the absence of device 39. However, bristles 43 engage surface portion 33, riding therealong as the rotor 30 turns, providing an electrically conductive path 44 to dissipate electrostatic charge that may otherwise build-up on the rotor 30. Accordingly, device 39 facilitates the equalization of electrostatic charge between the rotor 30 and the engine structure 22 and correspondingly reduces the potential difference between the rotor 30 and engine structure 22 that might otherwise result from electrostatic charge accumulation. The threat of any arcing due to such potential difference is reduced commensurately. It should be appreciated that for this arrangement, at least a portion of structure 22, such as housing 24, can be designated as an electrical ground, for which device 39 can be considered an electrical grounding structure.

In a further embodiment of the present application, an apparatus comprises a thrust-producing engine that includes an engine structure, a rotor that is electrically isolated from the engine structure by one or more bearings, and an electrostatic charge control device. The electrostatic charge control device is connected to the engine structure, and is in electrical contact with the engine structure and the rotor to define an electrical pathway while the rotor rotates relative to the engine structure to reduce electrical arcing between the engine structure and the rotor. The pathway can be more electrically conductive than the bearings.

Another embodiment includes operating a thrust-producing engine including an engine structure, a rotor that is electrically isolated from the engine structure by one or more electrically nonconductive bearings, and an electrical conductor connected to the engine structure. The rotor is turned relative to the engine structure and electrical conductor during engine operation. A mechanical bias is provided to press the electrical conductor against the rotor as the rotor turns. While the rotor turns, the electrical conductor slides along at least a portion of a circumferential surface of the rotor to make electrical contact therewith and reduce, if not eliminate, electrostatic charge build-up of the rotor relative to the engine structure.

In yet another embodiment, an apparatus comprises a thrust-producing engine that includes an engine structure, a rotor electrically isolated from the engine structure, and an electrostatic charge control device including a brush. The brush is secured to the engine structure to establish an electric charge pathway between the engine structure and the rotor to reduce arcing caused by electrostatic charge of the rotor.

In still another embodiment, a thrust-producing engine includes an engine structure, a rotor electrically isolated from the engine structure by one or more electrically nonconductive bearings, and an electrical conductor connected to the engine structure. During the operation of the engine, the rotor turns relative to the engine structure. While the rotor is rotating the electrical conductor electrically contacts the rotor to reduce, if not eliminate, build-up of electrostatic charge of the rotor relative to the engine structure.

A further embodiment includes: operating a thrust-producing engine comprising an engine structure, a rotor electrically isolated from the engine structure, and an electric charge control device connected to the engine structure; turning the rotor relative to the engine structure during engine operation; providing a mechanical bias to press a portion of the control device against the rotor as the rotor turns; and sliding the portion of the control device along at least a portion of a circumferential surface of the rotor to make electrical contact therewith to reduce electrostatic charge build-up of the rotor relative to the engine structure.

Still a further embodiment comprises a thrust-producing engine including an engine structure, a rotor electrically isolated from the engine structure, and an electric charge control device connected to the engine structure. The control device includes means for providing a mechanical bias to press a portion of the control device against the rotor as the rotor turns and means for sliding the portion of the control device along at least a portion of a circumferential surface of the rotor to make electrical contact therewith to reduce electrostatic charge build-up of the rotor relative to the engine structure.

Yet a further embodiment is directed to a thrust-producing engine that includes: an engine structure; a rotor electrically isolated from the engine structure; and a brush secured to the engine structure that is in electrical contact with the rotor to form an electric charge pathway between the engine structure and the rotor to reduce electrostatic charge build-up of the rotor relative to the engine structure.

Another embodiment comprises: operating a thrust-producing engine including an engine structure, a rotor electrically isolated from the engine structure by one or more electrically nonconductive bearings, and an electrical conductor connected to the engine structure; rotating the rotor relative to the engine structure during rotation of the rotor; and electrically contacting the rotor with the electrical conductor to dissipate electrostatic charge of the rotor relative to the engine structure during the rotor rotation.

Yet another embodiment comprises a thrust-producing engine that includes an engine structure, a rotor electrically isolated from the engine structure by one or more electrically nonconductive bearings, and an electrical conductor connected to the engine structure. The engine includes means for rotating the rotor relative to the engine structure and means for electrically contacting the rotor with the electrical conductor to dissipate electrostatic charge of the rotor relative to the engine structure during the rotor rotation.

In a further embodiment, an engine includes an engine structure, a rotor that is electrically isolated from the engine structure by one or more electrically nonconductive bearings, and an electrical conductor connected to the engine structure. As the rotor turns relative to the conductor and the engine structure, the conductor makes electrical contact with the rotor to reduce electrostatic charge build-up that could otherwise cause arcing.

While the invention has been illustrated and described in detail in the drawings and foregoing description, the same is to be considered illustrative and not restrictive in character, it being understood that only selected embodiments have been shown and described and that all changes, equivalents, and modifications that come within the scope of the inventions described herein or defined by the following claims are desired to be protected. Any experiments, experimental examples, or experimental results provided herein are intended to be illustrative of the present invention and should not be construed to limit or restrict the invention scope. Further, any theory, mechanism of operation, proof, or finding stated herein is meant to further enhance understanding of the present invention and is not intended to limit the present invention in any way to such theory, mechanism of operation, proof, or finding. In reading the claims, words such as “a”, “an”, “at least on”, and “at least a portion” are not intended to limit the claims to only one item unless specifically stated to the contrary. Further, when the language “at least a portion” and/or “a portion” is used, the claims may include a portion and/or the entire item unless specifically stated to the contrary.

What is claimed is:

1. An apparatus, comprising:
a thrust-producing engine, including:
an engine structure;
a rotor electrically isolated from the engine structure by at least one bearing; and
an electrostatic charge control device connected to the engine structure, the control device being in electrical contact with the engine structure and the rotor to define an electrical pathway therebetween as the rotor rotates relative to the engine structure to reduce electrical arcing between the engine structure and the rotor, the pathway being more electrically conductive than the at least one bearing.

2. The apparatus of claim 1, wherein the thrust-producing engine is a gas turbine engine.

3. The apparatus of claim 1, wherein the at least one bearing is a nonconductive bearing selected from a magnetic bearing, a rolling element bearing having a ceramic rolling element, a foil leaf air bearing and a fluid film bearing.

4. The apparatus of claim 1, wherein the control device includes a brush coupled to the engine structure, the brush being in electrical contact with the rotor.

5. The apparatus of claim 1, wherein the control device includes an electrically non-conductive leaf spring coupled to the engine structure, at least a portion of the leaf spring being in electrical contact with the rotor.

6. The apparatus of claim 4, wherein the rotor includes a conductive wear coating disposed over at least a portion of the rotor in contact with the brush.

7. A method, comprising:
operating a thrust-producing engine comprising an engine structure, a rotor electrically isolated from the engine structure, and an electric charge control device connected to the engine structure;
turning the rotor relative to the engine structure during engine operation;
pressing a portion of the control device against the rotor as the rotor turns; and
during the turning, sliding the portion of the control device along at least a portion of a circumferential surface of the rotor to make electrical contact therewith to reduce electrostatic charge build-up of the rotor relative to the engine structure.

8. The method of claim 7, which further includes electrically isolating the rotor from the engine structure with one or more nonconductive bearings positioned between the rotor and engine structure.

9. The method of claim 8, wherein the one or more nonconductive bearings including at least one of a magnetic bearing,a bearing having ceramic rolling elements, a foil leaf air bearing and a fluid film bearing.

10. The method of claim 7, wherein the control device includes an electrical conductor in the form of an electrically conductive brush with a plurality of bristles to make electrical contact with the circumferential surface of the rotor.

11. The method of claim 10, wherein the circumferential surface includes an electrically conductive wear-resistant coating.

12. The method of claim 7, wherein the control device includes a first end fixed to the engine structure and a second end in electrical contact with the rotor, and wherein said pressing is associated with elastically deforming at least a portion of the control device to impart a spring force to press the portion of the control device against the rotor.

13. An apparatus, comprising: a gas turbine engine, including:
an engine structure;
a rotor electrically isolated from the engine structure; and
a brush secured to the engine structure and being in electrical contact with the rotor to form an electric charge pathway between the engine structure to reduce electrostatic charge build-up of the rotor.

14. The apparatus of claim 13, wherein the gas turbine engine is a thrust-producing engine.

15. The apparatus of claim 14, wherein the engine includes one or more electrically nonconductive bearings in contact with the engine structure and the rotor.

16. The apparatus of claim 15 wherein the one or more nonconductive bearings includes one or more of a magnetic bearing, a ceramic bearing, a foil leaf air bearing and a fluid film bearing.

17. The apparatus of claim 14, wherein the rotor includes an electrically conductive wear coating disposed over at least a portion of the rotor positioned to make the electrical contact with the brush.

18. A method, comprising:
operating a thrust-producing engine including an engine structure, a rotor electrically isolated from the engine structure by one or more bearings, and an electrical conductor electrically connected to the engine structure;
during the operating, rotating the rotor relative to the engine structure; and
electrically contacting the rotor with the electrical conductor to dissipate electrostatic charge of the rotor relative to the engine structure during rotor rotation, the conductor defining an electrical pathway that is more electrically conductive than the one or more bearings.

19. The method of claim 18, wherein the one or more nonconductive bearings include at least one of an air bearing, a ceramic bearing, a foil leaf air bearing and a fluid film bearing.

20. The method of claim 18, wherein the electrical conductor includes a brush to slidingly engage at least a portion of a circumferential surface of the rotor as the rotor rotates.

21. The method of claim 20, wherein the circumferential surface includes an electrically conductive wear coating.
